(19) United States
(12) Patent Application Publication
(10) Pub. No.: US 2012/0317489 A1
(43) Pub. Date: Dec. 13, 2012

(54) Method and Apparatus Providing for Transmission of a Content Package

(75) Inventors: Mika Kuulusa, Tampere (FI); Henrik Hakala, Tampere (FI); Aki Happonen, Kiiminki (FI)

(73) Assignee: NOKIA CORPORATION, Espoo (FI)

(21) Appl. No.: 13/577,369

(22) PCT Filed: Feb. 9, 2010
(86) PCT No.: PCT/IB10/50587

§ 371 Date: Aug. 6, 2012

(51) Int. Cl. G06F 15/16; G06F 3/01

(52) U.S. Cl. 715/733

(57) ABSTRACT

An apparatus for providing for improved transmission of a content package may include a gesture recognizer configured to recognize gesture inputs on a touch screen which select content for transmission. A communication interface may search for signals from accessible devices, and a received signal strength meter may determine corresponding received signal strengths. A target device selector may select a target device from the accessible devices based at least in part on the received signal strengths. The communication interface may then provide for transmission of a content package including the content and configured for reception by the target device in instances in which the target device is selected. A corresponding method and computer program product are also provided.

### TECHNOLOGICAL FIELD

Embodiments of the present invention relate generally to content sharing technology and, more particularly, relate to an apparatus, method and a computer program product providing for transmission of a content package.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of content transfer.

Current and future networking technologies continue to facilitate ease of content transfer and convenience to users by expanding the capabilities of mobile electronic devices. Some such technologies are particularly useful in sharing content directly between devices. One such technology is that of BLUETOOTH® content sharing. However, using these technologies often involves a relatively complicated process in order to share content whereby the transmitting device searches for accessible devices, the user manually selects and/or confirms the selection of the accessible device to which transmission of the content is desired, and then the device shares a link key used to encrypt communications between the transmitting device and the receiving device. The name of the device intended to receive the content may be difficult to determine because it may be set by default to a random or generic name. If an incorrect name is selected, the user may attempt to transfer content to an unintended recipient device. The process may further require the entry of the same code in both of the devices. Thus, the pairing process may be relatively time consuming and complicated for the average user.

In order to reduce this inconvenience, the pairing process may only need to be conducted once between the particular transmitting and receiving devices. However, usability of the pairing process may not be substantially improved by this, because often times content sharing may not occur regularly between the two particular devices, but rather the content sharing may occur only upon a first meeting between the users of the two devices. For example, users of two devices, upon first meeting, may desire to share contact information with one another. In such circumstances future content sharing may not be anticipated, and thereby a relatively complicated and lengthy pairing process may not be ideal.

Accordingly it may be desirable to provide an improved method and apparatus providing for transmission of a content package.

### BRIEF SUMMARY OF THE INVENTION

A method, apparatus and computer program product are therefore provided that may provide improved transmission of content. Thus, for example, it may be possible to more easily transmit content to a target device.

In an exemplary embodiment, an improved method providing for transmission of a content package is provided. The method may include receiving a user selection of content for transmission, searching for one or more signals corresponding to one or more accessible devices, determining one or more received signal strengths for the one or more signals, selecting a target device from the accessible devices based at least in part on the one or more received signal strengths, and providing for transmission of a content package comprising the content and configured for reception by the target device in instances in which the target device is selected.

In an additional exemplary embodiment a computer program product comprises at least one computer-readable storage medium having computer-executable program code portions stored therein, the computer-executable program code portions comprising program code instructions for receiving a user selection of content for transmission, program code instructions for searching for one or more signals corresponding to one or more accessible devices, program code instructions for determining one or more received signal strengths for the one or more signals, program code instructions for selecting a target device from the accessible devices based at least in part on the one or more received signal strengths, and program code instructions for providing for transmission of a content package comprising the content and configured for reception by the target device in instances in which the target device is selected.

In a further exemplary embodiment an apparatus comprising at least one processor and at least one memory including computer program code is provided wherein the at least one memory and the computer program code are configured to, with the processor, cause the apparatus to at least perform receiving a user selection of content for transmission, searching for one or more signals corresponding to one or more accessible devices, determining one or more received signal strengths for the one or more signals, selecting a target device from the accessible devices based at least in part on the one or more received signal strengths, and providing for transmission of a content package comprising the content and configured for reception by the target device in instances in which the target device is selected.

Accordingly, embodiments of the present invention may provide for improved transmission of a content package.

### BRIEF DESCRIPTION OF THE SEVERAL VIEWS OF THE DRAWING(S)

Having thus described the present disclosure in general terms, reference will now be made to the accompanying drawings, which are not necessarily drawn to scale, and wherein:

FIG. 1 illustrates a schematic block diagram of a system according to an exemplary embodiment of the present invention;

FIG. 2 illustrates a schematic block diagram of an apparatus providing for transmission of a content package according to an exemplary embodiment of the present invention;

FIG. 3 illustrates a user terminal employing features of the apparatus of FIG. 2 according to an exemplary embodiment of the present invention; and

FIG. 4 illustrates a flowchart according to an exemplary method providing for transmission of a content package according to an exemplary embodiment of the present invention.

### DETAILED DESCRIPTION OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

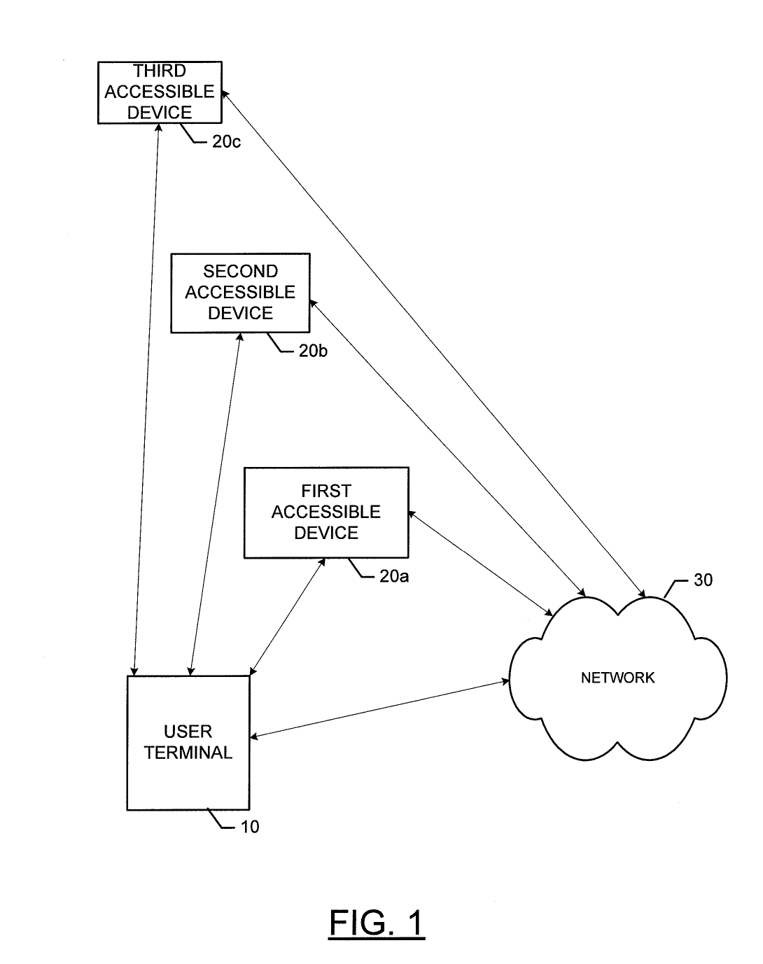

As indicated above, embodiments of the present invention may be employed in methods, apparatuses and computer program products in order to provide for transmission of a content package. In this regard, for example, FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention.

Moreover, although BLUETOOTH® is referred to as one example of a content sharing technology, it should be understood that embodiments of the present invention are not limited to applications using BLUETOOTH®, but may be used in connection with other wireless technologies.

As shown in FIG. 1, an embodiment of a system in accordance with an example embodiment of the present invention may include a user terminal 10. The user terminal 10 may be any of multiple types of fixed or mobile communication and/or computing devices such as, for example, portable digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, and other types of voice and text communications systems, which employ embodiments of the present invention. The user terminal 10 is configured to share content with one or more accessible devices 20a, 20b, 20c (collectively, 20). Content, as used herein, may include programs, applications, virtual business cards, emails, photographic image files, video files, audio files, and other forms of software, files, and electronically embodied information. Content thus refers to all types of data and is not limited to use on any particular embodiment of an electronic device.

The user terminal 10 may be capable of communicating with the accessible devices 20, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), e.g., the Internet. In turn, other devices such as processing elements (e.g., personal computers, server computers or the like) may be included in or coupled to the network 30. By directly or indirectly connecting the user terminal 10 and the other devices to the network 30, the user terminal 10 and/or the other devices may be enabled to communicate with each other, for example, according to numerous communication protocols including Hypertext Transfer Protocol (HTTP) and/or the like, to thereby carry out various communication or other functions of the mobile terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity. However, as previously stated, in some embodiments some communication may occur directly as opposed to through the network 30. In such embodiments communication may occur, for example, via a BLUETOOTH® connection. However, other types of wireless communication can be employed such as via WLAN or other types of proximity wireless communication. In an exemplary embodiment, the user terminal 10 shares content directly with one or more of the accessible devices 20. Thus, if a user of the mobile terminal 10 wants to provide the user of the first accessible device 20a with content, the mobile terminal is configured to do so. This could be the case, for example, when the mobile terminal 10 contains content in the form of a virtual business card, mp3, photo, etc. which the user desires to share with the user of the first accessible device 20a. While known embodiments of systems allow for sharing of content, embodiments of the present system provide advantageous functionality which may facilitate the transfer of the content. In particular, as described above, conventional pairing arrangements may require relatively extensive user interaction. Further, the interaction may possibly result in the attempted transfer of content to an unintended recipient device due to the potential for the name of the intended receiving device being difficult to determine. This interaction may of course correspond to increased time to complete the transfer of the content, which is undesirable. Accordingly, the user terminal 10 comprises features intended to reduce the user interactivity required to transfer content and thereby simplify the content transfer process, as will be described below.

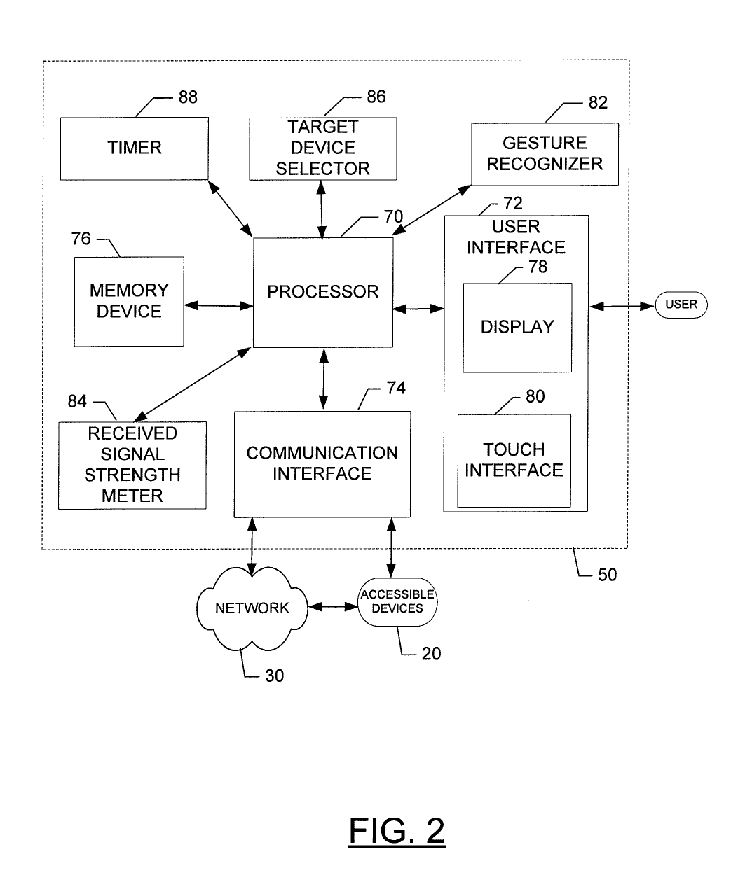

In an exemplary embodiment, an apparatus 50 is provided that may be employed by devices performing exemplary embodiments of the present invention. The apparatus 50 may be embodied, for example, as any device hosting, including, controlling or otherwise comprising the user terminal 10. However, embodiments may also be embodied on a plurality of other devices such as for example where instances of the apparatus 50 may be embodied on the network 30. As such, the apparatus 50 of FIG. 2 is merely an example and may include more, or in some cases less, than the components shown in FIG. 2.

With further regard to FIG. 2, the apparatus 50 providing for transmission of a content package is provided. As will be described below, a content package may comprise both the content which is being shared and related data. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases or storage locations that store information and/or media content.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions. In an exemplary embodiment the communication interface 74 may be used to search for one or more signals corresponding to one of the accessible devices 20 and thereafter transmit content to a target device selected from the accessible devices.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus 50 is embodied as the user terminal 10, the user interface 72 may include a display 78 and a touch interface 80, which may together define a touch screen 78/80. The touch screen 78/80 may thereby be used to control the apparatus 50 and conduct operations associated therewith. For example, the touch screen 78/80 may be used to select content for transmission.

In some embodiments the apparatus 50 may include a gesture recognizer 82. The processor 70 may be embodied as, include or otherwise control the gesture recognizer 82. The gesture recognizer 82 may employ or embody logic which converts user gesture inputs into recognized inputs. For example, the gesture recognizer 82 may be configured to recognize alphanumerical characters received by the apparatus 50 in the form of gesture inputs. Thus, in an exemplary embodiment, when the gesture recognizer 82 recognizes a gesture input substantially in the shape of an S, it may interpret the gesture input to mean that the user is selecting content for transmission.

In some embodiments the gesture inputs may be received by the touch interface 80, as for example when it is embodied as part of the touch screen 78/80. In embodiments such as those in which the apparatus 50 comprises a touch screen 78/80, the apparatus may receive a gesture input directly on a graphical representation of the content. For example, the gesture recognizer 82 may be configured to conduct a specified operation when a predetermined gesture input is received on a graphical representation of the content, such as a displayed image corresponding to a picture file.

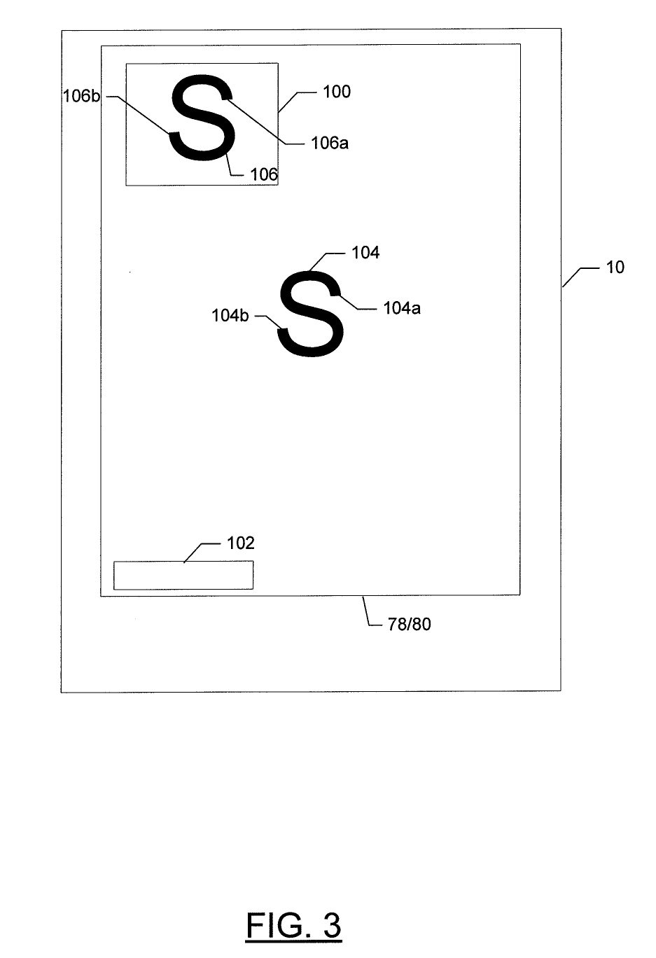

In an exemplary embodiment, the gesture recognizer 82 may be configured to recognize a gesture input in the shape of an S on a graphical representation of the content, and interpret it to mean that the user is selecting the content for transmission. For example, FIG. 3 illustrates an embodiment of the user terminal 10 when it embodies features of the apparatus 50. As illustrated, the user terminal 10 includes the touch screen 78/80, on which content 100 is displayed. The content 100 may, for example, be a picture, virtual business card, or other content which the user wishes to send. In one embodiment, user selection of the content 100 may occur via a menu input 102, which may be embodied on the screen 78 and usable via the touch interface 80, or it may alternatively or additionally be accessible via alternate input means and devices such as a physical keypad. However, in an alternate embodiment, selection of the content 100 may occur by gesturing on the touch screen 78/80. In some embodiments the user could make a gesture 104 on an unused portion of the display 78 to bring up an option to transmit the content 100. In an alternate embodiment, the user may make a gesture 106 on the graphical representation of the content 100 displayed on the display 78 in order to select the content for transmission. As will be explained below, this gesture input may in some embodiments be the only user interaction required in order to send the content 100. In the illustrated embodiments, the gestures 104, 106 are in the shape of an S. The mobile terminal 10, such as through the gesture recognizer 82, may be configured to recognize substantially S-shaped gestures which are drawn starting with a top portion 104a, 106a and ending at a bottom portion 104b, 106b. The mobile terminal 10 may also be configured to recognize substantially S-shaped gestures which are drawn starting with the bottom portion 104a, 106a and ending at the top portion 104b, 106b. However, as may be understood, various other embodiments of gestures may be used to select the content 100 for transmission. For example, in some embodiments, the gesture input which selects the content 100 may be user defined.

Returning to FIG. 2, in another exemplary embodiment, the processor 70 may be embodied as, include or otherwise control a received signal strength meter 84. For example, when using BLUETOOTH®, a driver performing this function may already be installed such as in S60 Symbian and Maemo Linux based systems. The received signal strength meter 84, according to some embodiments, is any means such as a device or circuitry embodied in hardware, software or a combination of hardware and software that is configured to perform determining one or more received signal strengths for one or more signals, such as by measuring the strength of signals received by the apparatus 50. In an exemplary embodiment the received signal strength meter 84 determines the respective signal strengths of one or more signals received by the communication interface 74 from the accessible devices 20.

In a further exemplary embodiment, the processor 70 may be embodied as, include or otherwise control a target device selector 86, which is configured to select the accessible device to which the content is transmitted. The target device selector 86, according to some embodiments, is any means such as a device or circuitry embodied in hardware, software or a combination of hardware and software that is configured to perform selecting a target device from the accessible devices 20 based at least in part on the received signal strengths, as may be determined by the received signal strength meter 84. Thus, in operations related to the selection of a target device, the received signal strength meter 84, the target device selector 86, or a combination thereof may sort the accessible devices based at least in part on the received signal strengths, and may further determine whether the received signal strengths exceed a received signal strength threshold.

Additionally, the processor 70 may be embodied as, include or otherwise control a timer 88. The timer 88, according to some embodiments, is any means such as a device or circuitry embodied in hardware, software or a combination of hardware and software that is configured to perform a timing function. In an exemplary embodiment the timer 88 may record the elapse of time after the apparatus 50 begins searching for signals corresponding to the accessible devices 20. Thus, for example, the timer 88 may be used to cause the apparatus 50 to stop searching for signals after a predetermined period of time if no signals are found to exceed the received signal strength threshold.

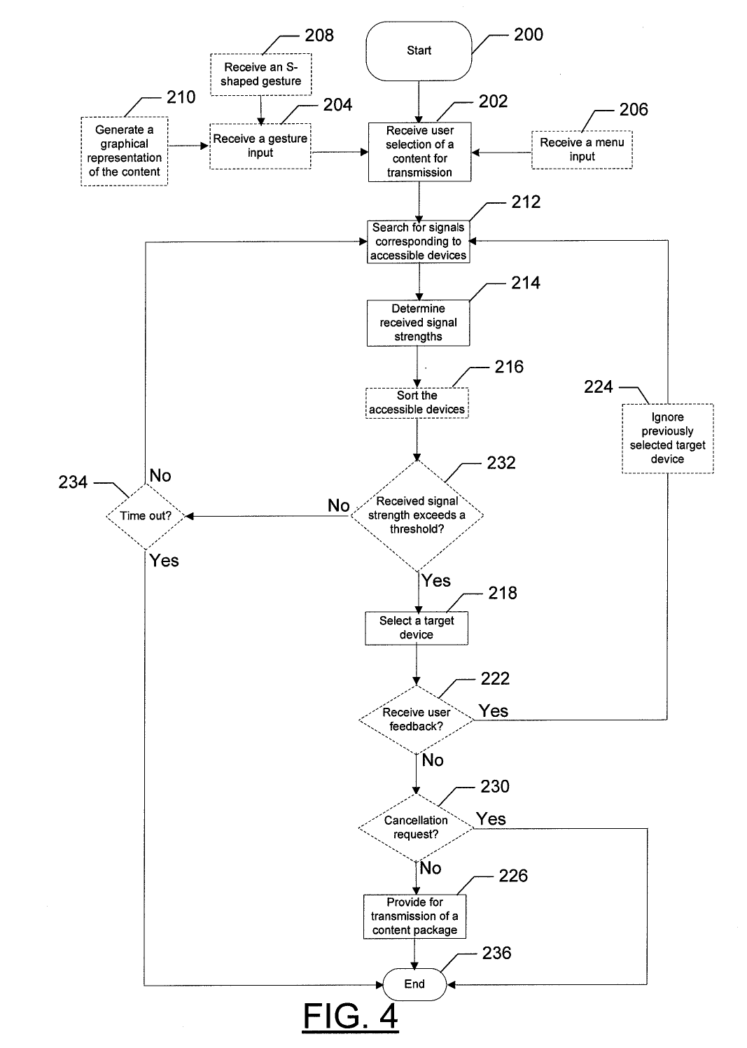

In terms of methods associated with embodiments of the present invention, the above-described apparatus or other embodiments of apparatuses may be employed. In this regard, FIG. 4 is a flowchart of a system, method and program product according to exemplary embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method providing for transmission of a content package as provided in FIG. 4 may start at block 200 and include receiving a user selection of content for transmission at operation 202. As indicated at blocks 204 and 206 respectively, the operation 202 of receiving the user selection of the content for transmission may comprise receiving a gesture input or receiving a menu input. Receiving the user selection of the content for transmission at operation 202 using the menu input, as indicated at block 206, may involve selection of the menu item using a keyboard or other physical device in some embodiments, but in other embodiments the menu item may be accessible via a touch screen. Further, in some embodiments the menu item may be accessible through a voice interface. When a gesture input is received as indicated at block 204, the method may further include receiving an S-shaped gesture, as indicated at block 208. Additionally or alternative, the method may include generating a graphical representation of the content at operation 210, on which the gesture input is received at operation 204. Thus, in some embodiments the selection of the content for transmission may occur with a single gesture input. Additionally or alternatively, a gesture input which may be used to select content for transmission may comprise a tap, that may be made either on top of the graphical representation of the content, or at a predefined spot such as beside the graphical representation of the content.

The method may further involve searching for one or more signals corresponding to one or more accessible devices at operation 212. Once one or more signals are found, the method further includes determining one or more received signal strengths for the one or more signals at operation 214. As indicated at operation 216, the method may further include sorting the accessible devices based on the received signal strengths. For example, FIG. 1 illustrates an example situation in which the first accessible device 20a is closest to the user terminal 10, the second accessible device 20b is second closest, and the third accessible device 20c is third closest. In such an embodiment, assuming substantially equal signal transmission strengths for each of the accessible devices 20 and no interference affecting the signal from one of the accessible devices more than the others, the signal strengths will likely be sorted from greatest to least in the same order of physical proximity. Accordingly, by sorting the accessible devices 20 based on received signal strengths, the method may approximate the physical proximity of the accessible devices.

After the received signal strengths are determined at operation 214, the operation 218 of selecting a target device from the accessible devices based at least in part on the one or more received signal strengths is conducted. In some embodiments the operation 218 of selecting a target device may comprise selecting one of the accessible devices with the greatest of the received signal strengths. In such embodiments the device employing the method may instruct the user to bring the desired target device into as close of proximity as possible in order to make it more likely that the desired target device is selected as the target device. Users may tend to do this naturally, however, because the sharing of physical items, such as physical business cards, generally requires close proximity.

However, if user feedback is received that indicates that a different target device is desired, as indicated at block 222, the method may thereafter ignore the previously selected device at operation 224. In this regard, the method may return to searching for signals corresponding to accessible devices at operation 212, as illustrated in FIG. 4. However, in alternate embodiments the method may return directly to the operation 218 of selecting a target device when additional signals corresponding to alternate accessible devices have been received and retained in memory. Regardless of the way in which the method determines what the remaining accessible devices are, the method may in some embodiments select the accessible device with the greatest received signal strength, excluding the previously selected target device. Hence, the method would thereby select the accessible device corresponding to the next greatest received signal strength. The method may once again allow the user to provide feedback at operation 222, and hence allow the user to iteratively move through the accessible devices to select the desired target device in some embodiments. For example, a listing of the potential accessible devices may be provided to the user and the user may scroll through the listing and select one of the potential accessible devices to be the desired target device. In one embodiment the listing may be sorted based upon the received signal strength of the respective accessible devices or the received signal strength may be provided along with each accessible device. However, as discussed above, in some embodiments the method will provide instructions to the user indicating that the user should move the desired accessible device such that it is the closest accessible device to thereby more likely lead the method to determine that the desired target device is the accessible device with the greatest received signal strength, and hence the accessible device selected as the target device.

The method further includes providing for transmission of a content package comprising the content and configured for reception by the target device at operation 226 in instances in which the target device is selected. The content package will include the content which has been selected at operation 202 and the content package may further comprise any information necessary for transmitting the content to the target device, such as encryption information. The operation 226 of providing for transmission of the content package may in some embodiments comprise providing for transfer the content package without pairing with the target device. For example, an ObjectPush profile may be used, which may not require pairing. Thus, in some embodiments it may not be necessary to share a link key or enter the same key in both devices. Further, as illustrated at block 230, the user may cancel the operation 226 of providing for transmission of the content package. In some embodiments a countdown timer may delay the operation 226 of providing for the transmission of the content package to give the user a predetermined period of time to cancel the transmission at block 230 prior to and/or during the operation 226 of providing for transmission of the content package. This may serve as a security feature in that if the method selects a target device which is not the desired target device and displays its name during/or before the transmission, the user may realize that it is the wrong accessible device and override and prevent the transfer of the content package.

In some embodiments of the method, the method may include determining whether the received signal strength exceeds a received signal strength threshold prior to providing for transmission of the content package, as indicated at block 232. In particular, the method may select a target device at operation 218 in instances in which the received signal strength exceeds the received signal strength threshold at block 232. However, in instances in which no received signal strength exceeds the received signal strength threshold when checked at block 232, the method may be configured such that a target device is not selected at operation 218 and providing for transmission of the content package at operation 226 does not occur until at least one of the received signal strengths exceeds the received signal strength threshold. By ensuring that the received signal strength exceeds the received signal strength threshold, the method may be more likely to select the desired target device for transmission of the content package. In this regard, the received signal strength threshold may be set to a relatively high absolute value intended to exclude accessible devices which are not relatively close in proximity. In one embodiment the device conducting the method and the accessible device must be nearly touching in order for normal BLUETOOTH® signals to meet the received signal strength threshold. Thus, the method may disregard relatively weak signals to ensure that the method configures the content for reception by only those accessible devices which are relatively close in proximity.

If a signal does not exceed the received signal strength threshold at block 232, in some embodiments a timer may be checked at block 234 to see if it has expired. The timer may begin recording the passage of time at an operation occurring during the method such as the operation 212 of searching for one or more signals corresponding to one or more accessible devices. Thus, if the predetermined time has not expired at operation 234, the method may continue iterating until a received signal strength exceeds the received signal strength threshold. However, if the predetermined time has expired at operation 234, in some embodiments the method may end, as shown at block 236. Therefore, the method can be configured to expire after a predetermined period of time to prevent the device executing the method from becoming stuck in an infinite loop if no received signal strength exceeds the received signal strength threshold at block 232. Accordingly, some embodiments of the method do not provide for transmission of the content package in instances in which the target device is not selected because none of the received signal strengths exceeds the received signal strength threshold. As may be noted from the above-described method, in some embodiments no user intervention is required in order to provide for transmission of content after it is selected. For example, in the method illustrated in FIG. 4, unless user feedback is received at block 222, or the user cancels transmission of the content package, as illustrated at block 230, the method will continue without further user involvement. Of course, in instances in which the operation 226 of providing for transmission of the content ultimately occurs after selection of the content at operation 202, at least one of the received signal strengths will have to exceed the received signal strength threshold at block 232 to thereby allow a target device to be selected at operation 218 in embodiments of the method in which the received signal strength is compared to a threshold. Accordingly, as compared to traditional pairing methods, the methods provided herein may present a relatively simpler way to transmit a selected content as part of a content package.

In a related method, pairing between a device and an accessible device such as a BLUETOOTH® headset may be accomplished by bringing the device and accessible device into close proximity, such as touching. The method may include searching for signals which exceed a received signal strength threshold, and then selecting the accessible device with the greatest received signal strength which exceeds the received signal strength threshold. The accessible device which is chosen by this process could then be paired with. Accordingly, a simplified method of pairing with accessible devices is also provided.

In an exemplary embodiment, an apparatus for performing the method of FIG. 4 and other methods described above may comprise a processor (e.g., the processor 70) configured to perform some or each of the operations (200-236) described above. The processor may, for example, be configured to perform the operations (200-236) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-236 may comprise, for example, the processor 70, the user interface 72, the communication interface 74, gesture recognizer 82, the received signal strength meter 84, the target device selector 86, the timer 88, and/or an algorithm executed by the processor 70 for processing information as described above.

For example, the operation 202 of receiving a user selection of content for transmission may be conducted by the user interface 72. When the content is selected via gesture inputs, as indicated at block 204, the gesture recognizer 82 may be employed. Further, the operation 212 of searching for signals corresponding to accessible devices may be conducted by the communication interface 74. Additionally, the operation 214 of determining received signal strengths may be carried out by the received signal strength meter 84. With regard to selecting a target device at operation 218, this may be conducted by the target device selector 86. Also, the operation 226 of providing for transmission of the content package at operation 226 may be carried out by the communication interface 74. Further, checking whether the received signal strength exceeds a threshold at block 232 may employ the received signal strength meter 84, and/or the target device selector 86. In embodiments which determine whether a period of time has expired at operation 234, this operation may be carried out by the timer 88. However, the above-described portions of the apparatus 50 as they relate to the operations of the method illustrated in FIG. 4 are merely exemplary, and it should be understood that various other embodiments may be possible.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-33. (canceled)

34. An apparatus comprising at least one processor and at least one memory including computer program code, the at least one memory and the computer program code configured to, with the processor, cause the apparatus to at least perform:
receiving a user selection of content for transmission;
searching for one or more signals corresponding to one or more accessible devices;
determining one or more received signal strengths for the one or more signals;
selecting a target device from the accessible devices based at least in part on the one or more received signal strengths; and
providing for transmission of a content package comprising the content and configured for reception by the target device in instances in which the target device is selected.

35. The apparatus of claim 34, wherein providing for transmission of the content comprises providing for transfer of the content package without pairing with the target device.

36. The apparatus of claim 34, wherein receiving a user selection of the content for transmission comprises receiving a gesture input on a graphical representation of the content.

37. The apparatus of claim 34, wherein selecting the target device comprises selecting one of the accessible devices with the greatest of the received signal strengths unless user feedback is received.

38. The apparatus of claim 34, wherein the program code further causes the apparatus to sort the accessible devices based on the received signal strengths.

39. The apparatus of claim 34, wherein the program code further causes the apparatus to determine whether at least one of the received signal strengths exceeds a received signal strength threshold prior to providing for transmission of the content package.

40. A method comprising:
receiving a user selection of content for transmission;
searching for one or more signals corresponding to one or more accessible devices;
determining one or more received signal strengths for the one or more signals;
selecting a target device from the accessible devices based at least in part on the one or more received signal strengths; and
providing for transmission of a content package comprising the content and configured for reception by the target device in instances in which the target device is selected.

41. The method of claim 40, wherein providing for transmission of the content comprises providing for transfer of the content package without pairing with the target device.

42. The method of claim 40, wherein receiving a user selection of the content for transmission comprises receiving a gesture input on a graphical representation of the content.

43. The method of claim 40, wherein selecting the target device comprises selecting one of the accessible devices with the greatest of the received signal strengths unless user feedback is received.

44. The method of claim 40, further comprising sorting the accessible devices based on the received signal strengths.

45. The method of claim 40, further comprising determining whether at least one of the received signal strengths exceeds a received signal strength threshold prior to providing for transmission of the content package.

46. A computer program product comprising at least one computer-readable storage medium having computer-executable program code portions stored therein, the computer-executable program code portions comprising:
program code instructions for receiving a user selection of content for transmission;
program code instructions for searching for one or more signals corresponding to one or more accessible devices;
program code instructions for determining one or more received signal strengths for the one or more signals;
program code instructions for selecting a target device from the accessible devices based at least in part on the one or more received signal strengths; and
program code instructions for providing for transmission of a content package comprising the content and configured for reception by the target device in instances in which the target device is selected.

47. The computer program product of claim 46, wherein program code instructions providing for transmission of the content comprise program code instructions for providing for transfer of the content package without pairing with the target device.

48. The computer program product of claim 46, wherein program code instructions for receiving a user selection of the content for transmission comprise program code instructions for receiving a gesture input on a graphical representation of the content.

49. The computer program product of claim 46, wherein program code instructions for selecting the target device comprise program code instructions for selecting one of the accessible devices with the greatest of the received signal strengths unless user feedback is received.

50. The computer program product of claim 46, further comprising program code instructions for sorting the accessible devices based on the received signal strengths.

51. The computer program product of claim 46, further comprising program code instructions for insuring that at least one of the received signal strengths exceeds a received signal strength threshold prior to providing for transmission of the content package.
